(19) United States
(12) Patent Application Publication
(10) Pub. No.: US 2003/0233777 A1
(43) Pub. Date: Dec. 25, 2003

(54) Non-polluting display device and an associated notice and notice board

(75) Inventor: Pavel Hammer, Oschingen (DE)

Correspondence Address: Edward G. Greive, Renner, Kenner, Greive, Bobak, Taylor & Weber, Fourth Floor, First National Tower, Akron, OH, 44308-1456, US

(73) Assignee: Aplix

(21) Appl. No.: 10/452,749

(22) Filed: Jun. 2, 2003

(30) Foreign Application Priority Data
Jun. 25, 2002 (FR) 0207837

(51) Int. Cl. G09F 7/02

(52) U.S. Cl. 40/611.01

(57) ABSTRACT

A display device comprising a board (1), a notice (4) comprising a sheet having a front and a back, information in text or image form being adapted to be applied e.g. by printing on the front, and means for securing the notice to the board, characterised in that the fixing means are made up of hooks and loops, the hooks extending from the main surface of the board for attaching the notice and the loops extending from the back of the notice, substantially the entire main surface of the board being covered with hooks.

The invention relates to a display device comprising a notice board; a notice comprising a sheet having a back and a front, information in text or image form being settable, e.g. by printing, on the front; and means for fixing the notice to the board. The invention also relates to a notice comprising a sheet having a back and a front, information in text or image form being set or settable on the front, e.g. by printing. The invention also relates to a notice board.

Display devices of this kind have developed particularly in recent decades, inter alia in the form of advertising or information boards which may be found practically anywhere in towns, in the underground, on the roadside etc.

To an increasing extent, the notices are made by very complicated reproduction processes on sheets which themselves are increasing in expense. Apart from the cost of the notices, the increase is due to the need to create an impression by a progressive improvement in quality. Also, particularly when large, the notices require special skill in setting them up, as regards the adhesive, the method of applying the adhesive to the board, the method of sticking the notice to the board etc.

The adhesive used frequently need special adhesive properties, e.g. must be liquid so that they can easily be brushed over the notices but must dry quickly after the notice has been posted. The adhesives therefore contain numerous chemical compounds which must not be allowed to harm the environment by spreading in the atmosphere.

Finally removal of the notices is not a simple process. They frequently have to be torn down, which takes time and is frequently messy, or else there is need for a new product containing chemical compounds for dissolving the adhesive, in which case the solvent is itself a pollutant which must not be released into the atmosphere.

Clearly, to avoid use of polluting adhesives and to obtain simple removal without leaving a trace (apart from holes in the notices), a simple solution would be to use pins or nails. Such a method, however, is of course particularly slow and difficult to work, particularly when the notices are very high and large. In the case of high notices, it is frequently desirable to use a sort of broom on which the notice, impregnated with adhesive, is placed and is applied to the board by vertical sweeping. This method cannot be used with fixing means comprising nails or pins.

The invention aims to obviate the disadvantages of the prior art by providing a display device wherein the notices can be fixed to the board by the same methods as in the case of sticking, or by similar and equally simple methods, without the need to use an adhesive or adhesive-removing products which are harmful to the environment.

According to the invention, the display device, comprising a board, a notice comprising a sheet having a front and a back, information in text or image form being adapted to be applied, e.g. by printing, to the back, and means for fixing the notice to the board, the fixing means comprising hooks and loops, is characterised in that the hooks extend from the main surface of the panel to which the notice has been fixed and the loops extend from the back of the notice.

Preferably substantially the entire main surface of the panel is hooked, inter alia more than 75% of the main surface.

Preferably the entire surface of the back has loops.

In the present application, “hooks” means any component for fixing one thing to another via a loop, e.g. a harpoon, a mushroom, or a stud with an enlarged head, as is conventional in the self-gripping sector.

In the present application, “surface with hooks” means a surface without any part without hooks, a surface without hooks being a part not having a hook over a distance wider than a usual spacing between two hooks. For example the space between two consecutive hooks in a hooked region cannot be considered as a region without hooks in the sense of the present application. A region with hooks is, for example, a region with hooks in a density greater than 1/cm².

In a preferred embodiment, a sheet with hooks on one surface is fixed by sticking, welding or any other method, via its other surface, to the main surface of the panel, the hooked surface of the sheet preferably comprising hooks over substantially its entire surface.

In a particularly easily workable embodiment, a loop material, e.g. a looped knitted or non-woven material, is fixed by sticking, coating, welding or any other method to the back of the notice, preferably over substantially the entire surface of the back.

Preferably the loop material comprises a warp and weft knitted fabric in which the loops are knitted and fixed e.g. by coating on to the back of the notice. The knitted fabric preferably weighs between 20 and 100 g/m², preferably between 25 and 50 g/m² and still more preferably between 30 and 40 g/m².

The density of the loops (number of loop bases per cm²) is 10 to 50, preferably 20 to 30/cm².

By thus providing a self-gripping connection via a light knitted fabric with loops on one surface and a sheet with hooks on the other surface for fixing, a particularly simple connection is obtained between the notice and the board and can be made by the same methods as with adhesives but can easily be removed, avoiding the use of polluting adhesive.

In a preferred embodiment of the invention, the sheet with hooks is made of a flexible material such as polypropylene, polyethylene, polyamide or mixtures thereof and the hooks extend from the sheet of similar material and have a height between 0.3 and 1 mm.

In another preferred embodiment of the invention, the hooks are in the shape of knitted mushrooms of polypropylene thread having a height of 1.3 mm (including the base) and a density of the order of 40 to 50/cm².

In another preferred embodiment of the invention, the loop material is a looped non-woven fabric.

The invention also relates to a notice comprising a sheet having a back and a front, information in text or image form being appliable e.g. by printing to the front and a loop material being fixed to the back, preferably over the entire surface of the back.

The invention also relates to a notice comprising a sheet having a front and a back, information in text or image form being appliable e.g. by printing to the front and a loop material being fixed to the back, preferably over substantially the entire surface of the back.

According to an improvement, the loop material is a knitted fabric in which loops are knitted, or is a looped non-woven, the knitted or non-woven fabric having a weight between 20 and 100 g/m², preferably between 25 and 50 g/m² or still more preferably between 30 and 40 g/m². The resulting notice is very flexible but easy to print and/or install. In particular the notice can be printed by passing it through an ordinary office printer. In particular the sheet can be a conventional sheet of office paper weighing between 60 and 150 g/m².

The invention also relates to a notice board for receiving a notice in the form of a sheet, hook means being fixed to the main surface, substantially to the entire surface, of the board for receiving the notice.

The following, by way of example, is a description of an embodiment with reference to the drawings in which:

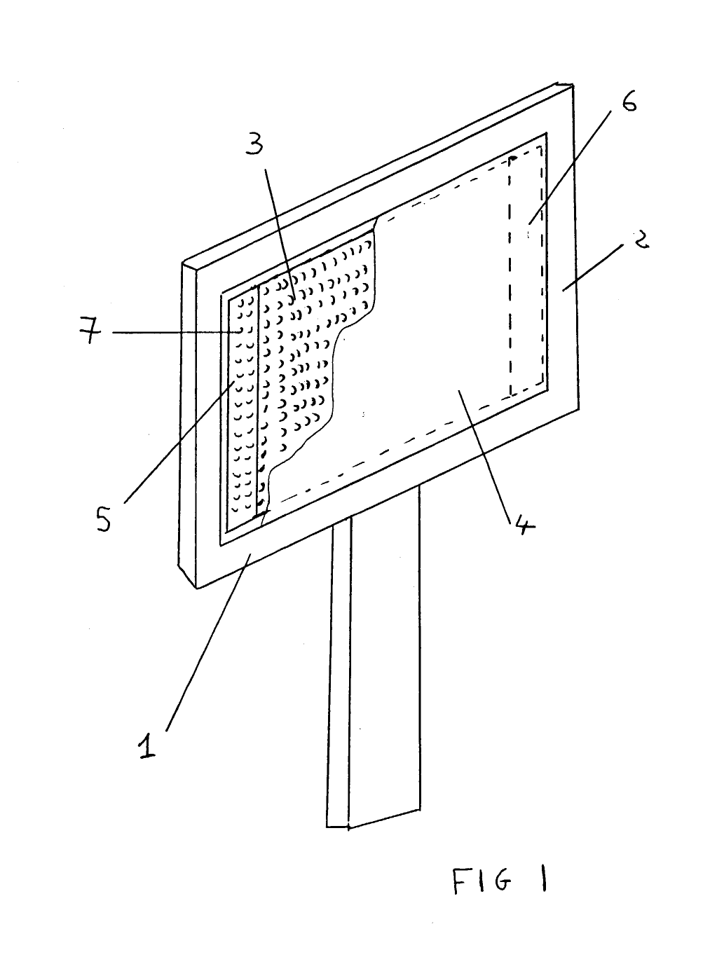

FIG. 1 is a perspective view of a display device according to the invention;

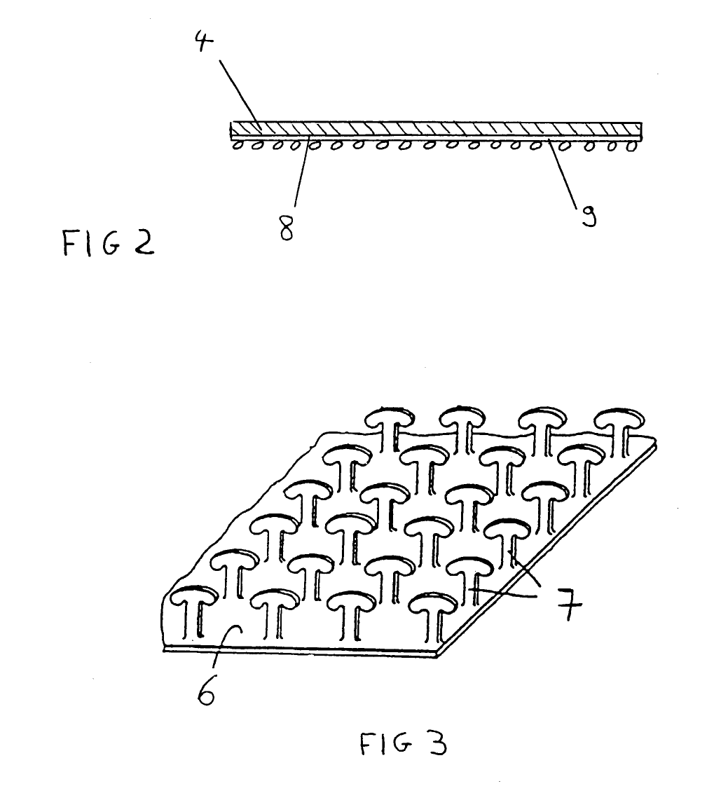

FIG. 2 is a side view of the notice on the display device in FIG. 1, and

FIG. 3 shows a sheet with hooks for the notice board in FIG. 1.

FIG. 1 shows a display device comprising a substantially rectangular board 1 bounded by a border or frame 2 around its entire periphery. The frame 2 defines a front or main surface of the board on which a notice is to be affixed. A sheet 5 with hooks 6 is stuck to the surface 3. The sheet with hooks is of polyethylene, polypropylene, polyamide and/or polyester and is between 0.1 and 0.5 mm thick.

The sheet 5 is stuck to the board 1, which is of wood or other weather-resistant material.

The gripping sheet 5 is disposed so as to lie continuously without any irregularity in the surface or difficulty in joining the various constituent components of the notice. The front 8 of the notice 4 bears information or advertising or images etc. The information is adapted to be read by the public when the notice 4 is posted on the board 1, e.g. alongside a road, at the entrance to a village or in the underground.

A looped knitted fabric 10 is attached e.g. by coating on to the back 9 of the notice 4, which is in the form of a sheet. The weight of the knitted fabric is 40 g/m². It can be between 20 and 100 g/m². The height of the loops, i.e. the maximum dimension of the loops, is e.g. between 1.6 and 2.5 mm. The adhesive used for coating has strong affinity both for the knitted material 10 and for the notice 4. The notice 4 is of paper. The knitted fabric 10 e.g. comprises a base and loops of 44/10 decitex polyamide thread, or a base and a 22/1 decitex polyamide thread and loops of 44/10 decitex polyamide thread or loops of 76/24 decitex polyester thread. The knitted fabric is made by interlacing warp threads, weft threads and loop threads, e.g. by shaping them on a three-bar loom.

In another embodiment, the loop material is a looped non-woven obtained e.g. from cables made from crimped filaments and having a thickness between 0.1 and 3 mm and a weight between 15 and 100 g/m².

In particular, the filaments can be polyolefins, polyamides, cellulose acetates etc.

FIG. 3 shows a looped sheet 5 with loops 6. The sheet 5, with loops 6 which extend directly from its top surface, can be made e.g. by the “lamelle” process described in French patent application number 9904331 published on Oct. 13, 1999 in the name of the Applicants. Of course there are alternative methods such as the Velcro drum process.

The extruded hooks have a density of 50 to 250/cm², preferably 100 to 200/cm².

1. A notice (4) comprising a sheet having a back (9) and a front (8), information in text or image form being applied or appliable to the front e.g. by printing, characterised by a loop material disposed on the back of the sheet.

2. A notice according to claim 1, characterised in that the loop material is disposed over substantially the entire surface of the back.

3. A notice according to claim 1, characterised in that the loop material is coated, stuck or welded to the back.

4. A notice according to claim 1, characterised in that the loop material is a knitted fabric wherein loops are knitted or a looped non-woven, the knitted or non-woven material weighing between 20 and 100 g/m², preferably between 25 and 50 g/m² and still more preferably between 30 and 40 g/m².

5. A notice according to claim 1, characterised in that the sheet is of paper weighing between 50 and 150 g/m².

6. A notice according to claim 5, characterised in that the sheet format is A3 or A4.

7. A notice board (1) adapted to receive a notice (4) according to claim 1, characterised in that hooks for attaching the notice extend from the main surface of the board.

8. A notice board (1) according to claim 7, characterised in that substantially the entire main surface of the board has hooks, inter alia more than 75% of the main surface.

9. A notice board (1) according to claim 1, characterised in that a sheet (5) comprising a substrate and hooks (6) projecting from one surface of the substrate is fixed by sticking, welding or otherwise attaching its other surface to the main surface of the board.

10. A notice board (1) according to claim 9, characterised in that the substrate has a thickness between 0.1 and 0.5 mm and the hooks (6) have a height between 0.3 and 1 mm.

11. A display device comprising a board according to claim 1 and a notice board according to any of claims 7 to 10.

12. A notice board (1) adapted to receive a notice (4) according to claim 7, characterised in that hooks for attaching the notice extend from the main surface of the board.
